(19) United States
(12) Patent Application Publication
(10) Pub. No.: US 2024/0143413 A1
(43) Pub. Date: May 2, 2024

(54) MANAGING EDGE COMPUTE SERVERS WITH A DATA CENTER ELEMENT MANAGER

(71) Applicant: Dell Products L.P., Round Rock, TX (US)

(72) Inventors: Jason YE, Shanghai (CN); Zheng ZHANG, Shanghai (CN); Donald MACE, Hopkinton, MA (US); Yongjun SHI, Shanghai (CN); Charlie CHEN, Shanghai (CN); Roy Shengli LING, Shanghai (CN)

(73) Assignee: Dell Products L.P., Round Rock, TX (US)

(21) Appl. No.: 17/975,334

(22) Filed: Oct. 27, 2022

(51) Int. Cl. G06F 9/50; G06F 8/61; G06F 16/188

(52) U.S. Cl. CPC G06F 9/5077; G06F 8/61; G06F 16/196; G06F 2209/505; G06F 2209/508

(57) ABSTRACT

Disclosed systems and methods for centrally managing distributed edge server resources may create a host folder, associate the host folder with an element manager, add one or more edge servers to the host folder, and manage the one or more edge servers with an edge server management system running in the applicable instance of the element manager. The host folder may be created from either a server manager UI or from an element manager UI. An edge server may be added to a host folder by invoking a UI of the element manager UI. Managing the one or more edge servers may include performing health monitoring of the edge servers as well as version checking and upgrading of the edge servers. An edge server agent may be deployed in the edge server to receive change events published by the edge server and redirect the change events to an element manager system.

### TECHNICAL FIELD

The present disclosure pertains to information handling systems and, more particularly, monitoring, maintaining, and distributed information handling system resources.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A distributed system is a type of information handling system in which two or more information handling system components may cooperate, communicate, or otherwise interact to provide a service or resource. Edge computing is an increasingly pervasive form of distributed system infrastructure in which cloud resources analyze big data while edge compute servers, also referred to herein simply as edge servers, and other edge resources receive and process data generated in real time by nearby and web-enabled sensors and users. The number of servers deployed in edge server environments is increasing to keep pace with the rapid and continuing increase in the number of data-generating edge devices and the daily volume of edge-generated data, resulting in massively scaled, distributed systems. It will be readily appreciated by those of ordinary skill in the distributed system and edge computing fields that monitoring and updating a large population of distributed servers, while simultaneously maintaining secure, highly available, and high performing applications and services is extremely challenging.

### SUMMARY

Challenges identified in the preceding description are addressed by disclosed methods and systems for managing potentially large populations of distributed edge computing resources. Disclosed systems and methods implement consistent processes and centralized management resources for monitoring the resource health and performance and for performing and controlling life cycle management operations for edge compute servers. Disclosed methods and systems expand the native capabilities of a data center element manager by leveraging management capabilities of a server manager running on a virtualization platform to implement user-defined and logical groupings of edge compute resources. In at least one implementation, capabilities of a widely distributed data center element manager, such as the VxRail Manager from Dell Technologies, which may be referred herein as VxRail cluster manager, are employed to manage edge compute servers by leveraging host folder features of a server manager running on a virtualization platform, e.g., a vCenter server manager running on a vSphere virtualization platform. Using this approach, users can create host folders that support logical groupings of edge compute servers and add edge compute servers to separate host folders being managed by the element manager.

In addition, disclosed systems and methods may perform life cycle management (LCM) operations and functions on the edge compute servers at the host folder level. With such tools, edge servers residing in a host folder can be moved between or among two or more managed host folders from a single element manager instance. By employing and expanding functionality for a VxRail Manager instance, or another suitable element manager, disclosed methods and system beneficially offer disclosed functionality, e.g., node addition, LCM functions, and alert/event monitoring, in the context of a familiar user interface experience.

In one aspect, disclosed systems and methods for centrally managing distributed edge server resources create a host folder, associate the host folder with an element manager, add one or more edge servers to the host folder, and manage the one or more edge servers with an edge server management system running in an applicable instance of the element manager. The host folder may be created from either a server manager UI or from an element manager UI. An edge server may be added to a host folder by invoking a UI of the element manager UI. In at least one embodiment, the element manager is implemented as a plugin UI for the server manager.

Managing the one or more edge servers may include performing health monitoring of the one or more edge servers. Such health monitoring may include deploying an edge server agent to receive change events published by the edge server and redirecting the change events to the edge server management system. Managing the one or more edges servers with the element manager may also include performing life cycle management of the one or more edge servers. In some embodiments, performing life cycle management of the one or more edge servers may include monitoring version information for the one or more edge servers to report information including, as illustrative examples, which edge servers are upgrade eligible and which versions can be applied to upgrade eligible servers. Performing life cycle management of the one or more edge servers may also include providing a user with version upgrading options including, as non-.limiting examples, direct upgrading wherein version upgrading commences when an upgrading bundle transfer completes and scheduled upgrading wherein version upgrades occur during a future maintenance window.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates exemplary operations for implementing a centralized edge server management system;

FIG. 2 illustrates an edge server management system for performing health monitoring of edge compute servers;

FIG. 3 illustrates an edge server management system for performing health monitoring of edge computer servers;

FIG. 4 illustrates a flow diagram of an edge computer server management method in accordance with disclosed teachings; and

FIG. 5 illustrates an exemplary information handling system suitable for use in conjunction with subject matter illustrated in FIGS. 1-4 and described in the corresponding portions of the detailed description.

### DETAILED DESCRIPTION

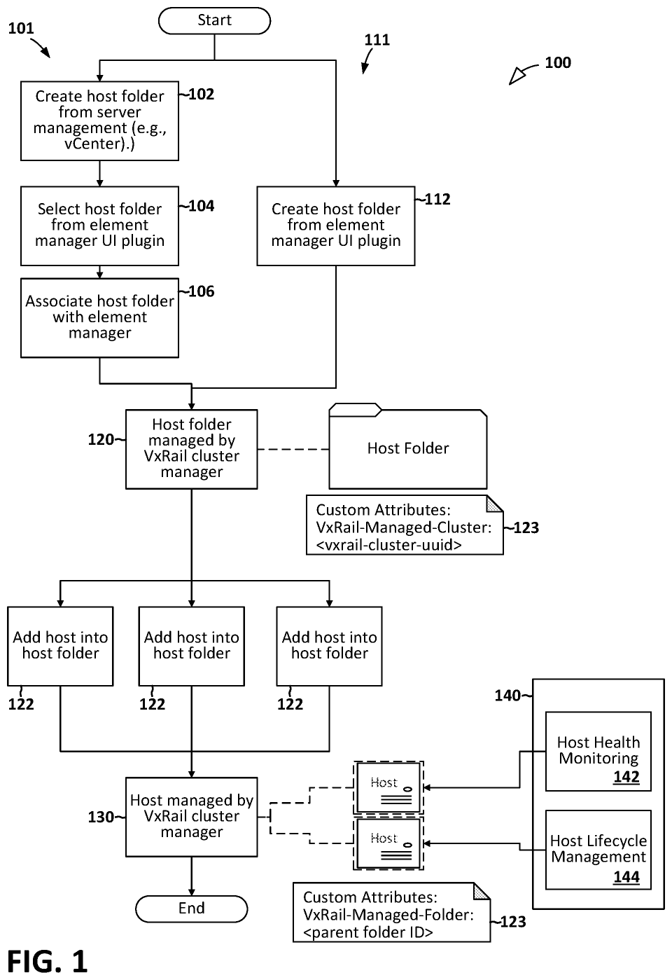

Exemplary embodiments and their advantages are best understood by reference to FIGS. 1-5, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Generally, systems and methods disclosed in the following detailed description leverage a data center element manager and host folder features of a server management resource to enable centralized management of distributed edge compute servers. The following description refers, in some instances, to specific makes, models, and/or brands of various disclosed elements for purposes of illustrating and explaining various features of disclosed systems and processes. Examples of specific resources referenced herein include VMware vCenter server management software and a VxRail Manager element manager from Dell Technologies. For the sake of brevity and clarity, the description may rely of a relatively small number of specific examples to disclose various features. Thus, references to vCenter, VxRail, VxRail Manager, and other specific makes or models are not intended to be limiting or exclusive and those of ordinary skill will recognize that disclosed teachings may be practiced in conjunction with makes and model not expressly referenced herein.

FIG. 1 illustrates a flow diagram of a method 100 for managing edge compute servers in accordance with disclosed teachings. As depicted in FIG. 1, method 100 begins by performing either of two operational sequences to create a host folder and associate the host folder with a VxRail Manager instance. The host folder can be created natively, via operational sequence 101, from a vCenter UI, or alternatively via operational sequence 111 using a VxRail Manager instance. The first operational sequence 101 illustrated in FIG. 1 begins by creating (operation 102) a host folder from a user interface (UI) of a vCenter instance. Operational sequence 101 further includes selecting (operation 104) a host folder from a VxRail Manager UI resource and associating (operation 106) the host folder with a VxRail Manager instance. The second operational sequence 111 illustrated in FIG. 1 includes, in the depicted example, just a single operation, operation 112, for creating a host folder directly, from a VxRail Manager UI. FIG. 1 further illustrates either of the operational sequences, 101 or 111, producing a host folder 120 managed by a VxRail Manager cluster. As depicted in FIG. 1, the establishment of host folder 120 is followed by one more operations 122, performed in series or in parallel, during which a host is added into host folder 120 to produce a host 130 managed by VxRail Management instance.

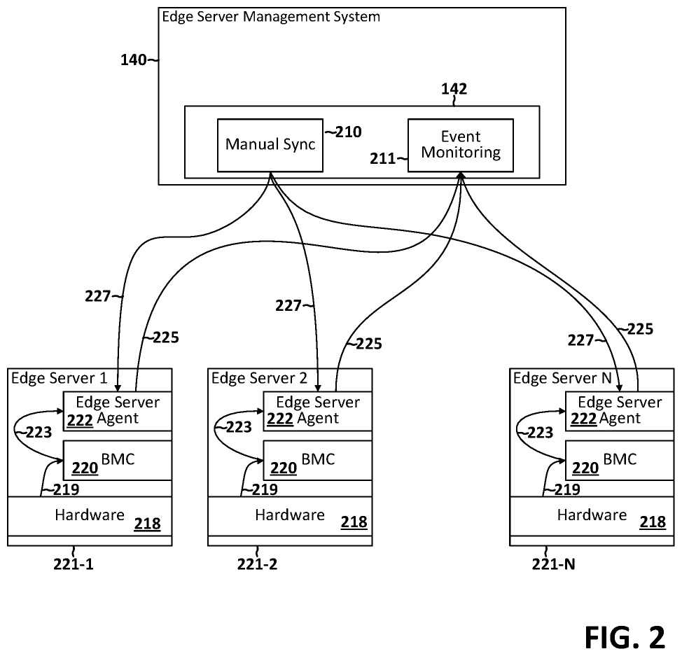

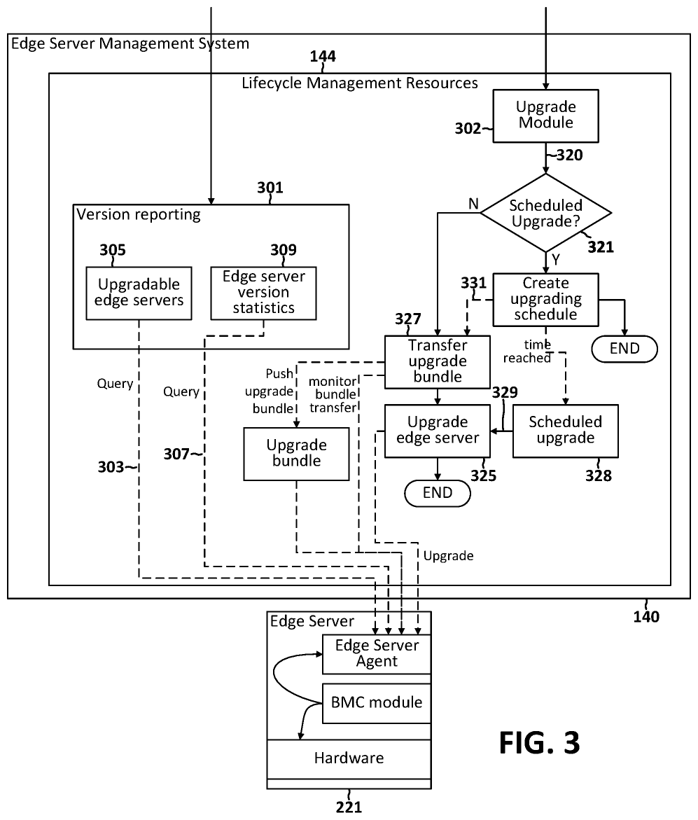

FIG. 1 further depicts a VxRail Manager Edge Server Management System 140 including a host health monitoring resource 142 and a host lifecycle management resource 144 described in more detail with respect to FIG. 2 and FIG. 3.

In at least some embodiments, metadata 123, including VxRail manager and host folder name, are kept in vCenter for each managed host folder and edge server. Host metadata is updated when a managed edge server is moved out of the current host folder.

Referring now to FIG. 2, an exemplary health monitoring resource 142 within VxRail Edge Server Management System 140 is depicted in communication with a group of distributed edge servers 221, of which FIG. 2 illustrates N such edge servers 221-1, 221-2, . . . 221-N.

Because the number of edge servers in a distributed system is potentially very large, health monitoring resource 142 should generate health monitoring network traffic as efficiently as possible. The illustrated health monitoring service 142 beneficially leverages event messaging functionality native to the baseboard management controller (BMC) 220 within each edge server 221. Each BMC 220, which may be implemented as an integrated remote access controller such as an iDRAC remote access controller from Dell Technologies, is natively provisioned with functionality for receiving event messages 219 generated by hardware 218. The edge servers 221 illustrated in FIG. 2 deploy an agent, identified in FIG. 2 as edge server agent 222, to receive (223) event messages from BMC 221 and redirect (225) those messages to an event monitoring module 211 in health monitoring resource 142. In addition, the health monitoring resource 142 of the VxRail Edge Server Management System 140 depicted in FIG. 2 includes an independent query path 227 and a corresponding triggering input, identified as Manual Sync 210, enabling users to retrieve or otherwise determine edge server status manually.

Referring now to FIG. 3, exemplary host lifecycle management (LM) resources 144 are illustrated. The LM resources 144 illustrated in FIG. 3 include version reporting resources 301 and a version upgrade module 302. Versions reporting resources 301 enable users to check or otherwise view version information for each edge server 221. The illustrated version reporting resources 301 support an upgradeable server query 303, which generates an upgradeable server report or view 305 indicating all upgrade-eligible edge servers 221 as well as the versions that can be applied, and a version statistics query 307, which generates a version statistics report or view 309 that can report version statistics grouped, for example, based on host folders, together with other valuable information.

The illustrated version upgrade module 302 enables users to either schedule or trigger version upgrades. If, as determined in block 321, an update request 320 is not a request for scheduled updates, i.e., a triggered update, then version upgrading (325) will start immediately after upgrade bundle transfer 327 completes. If a user elects scheduled upgrades, a scheduler 328 is saved, e.g., in the element manager, and upgrade is initiated (329) at the scheduled time. In at least some embodiments, the upgrade module resources may beneficially trigger (331) upgrade bundle transfer 327 when the upgrade is scheduled, rather than waiting until the scheduled time to arrive and thereby incurring a delay while the upgrade bundle is transferred.

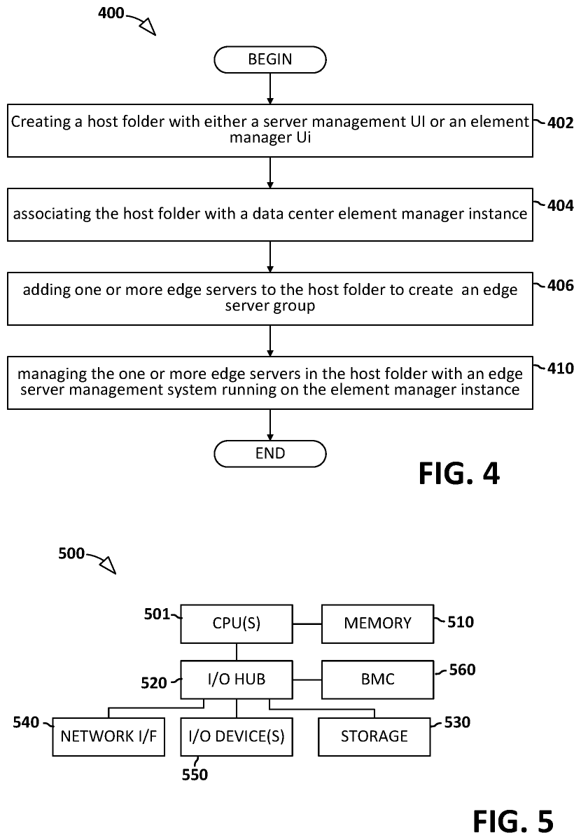

Referring now to FIG. 4, a flow diagram illustrates a method 400 for managing a plurality of distributed edge servers in accordance with disclosed teachings. As illustrated in FIG. 4, method 400 includes creating (operation 402) a host folder with which one or more edge servers will be associated for purposes of performing management functions including functions disclosed in the preceding description of FIG. 2 and FIG. 3. The host folder may be created natively from a server manager, such as a vCenter client, or from an element manager UI, such as a VxRail Manager UI. The method 400 illustrated in FIG. 4 further includes associating (operation 404) the host folder with a data center element manager instance such as a VxRail Manager instance running on a virtualization platform, such as a vSphere virtualization platform, implemented with a hyperconverged infrastructure (HCI) appliance, such as any VxRail HCI appliance from Dell Technologies. One or more edge servers may then be added (operation 406) to the host folder to create an edge server group that may, for example, be provisioned or otherwise managed in parallel. In accordance with the illustrated method 400, one or more edge servers may then be managed (operation 410) with an edge server management system running on the element manager instance. In this manner, the disclosed method beneficially implements centralized management of a potentially large number of edge servers via creative use and repurposing of existing virtualization and management resources.

Referring now to FIG. 5, any one or more of the elements illustrated in FIG. 1 through FIG. 4 may be implemented as or within an information handling system exemplified by the information handling system 500 illustrated in FIG. 5. The illustrated information handling system includes one or more general purpose processors or central processing units (CPUs) 501 communicatively coupled to a memory resource 510 and to an input/output hub 520 to which various I/O resources and/or components are communicatively coupled. The I/O resources explicitly depicted in FIG. 5 include a network interface 540, commonly referred to as a NIC (network interface card), storage resources 530, and additional I/O devices, components, or resources 550 including as non-limiting examples, keyboards, mice, displays, printers, speakers, microphones, etc. The illustrated information handling system 500 includes a baseboard management controller (BMC) 560 providing, among other features and services, an out-of-band management resource which may be coupled to a management server (not depicted). In at least some embodiments, BMC 560 may manage information handling system 500 even when information handling system 500 is powered off or powered to a standby state. BMC 560 may include a processor, memory, an out-of-band network interface separate from and physically isolated from an in-band network interface of information handling system 500, and/or other embedded information handling resources. In certain embodiments, BMC 560 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An edge server management method, comprising:
creating a host folder;
associating the host folder with an element manager;
adding one or more edge servers to the host folder; and
managing the one or more edge servers with an edge server management system running in the element manager instance.

2. The method of claim 1, wherein creating the host folder comprises creating the host folder from a server manager running in a virtualization platform user interface (UI).

3. The method of claim 1, wherein creating the host folder comprises creating the host folder from an element manager user interface (UI).

4. The method of claim 1, wherein the adding of the edge server to a host folder comprises adding the edge server via the element manager user interface (UI).

5. The method of claim 4, wherein the element manager UI comprises a plugin UI for the server manager running on a virtualization platform.

6. The method of claim 1, wherein managing the one or more edge servers includes performing health monitoring of the one or more edge servers.

7. The method of claim 6, wherein performing the health monitoring includes deploying an edge server agent to:
receive change events published by the edge server; and
redirect the change events to an element manager system.

8. The method of claim 7, wherein deploying the edge server agent comprises deploying the edge server agent to receive change events published by a baseboard management controller of the edge server.

9. The method of claim 1, wherein managing the one or more edge servers with the element manager includes performing life cycle management of the one or more edge servers and wherein the performing of life cycle management includes:
monitoring version information for the one or more edge servers to report information including:
which edge servers are upgrade eligible; and
which versions can be applied to upgrade eligible servers.

10. The method of claim 9, wherein performing life cycle management of the one or more edge servers includes providing a user with version upgrading options including:
direct upgrading wherein version upgrading commences when an upgrading bundle transfer completes; and
scheduled upgrading wherein version upgrading commences during a future maintenance window.

11. An information handling system, comprising
a central processing unit (CPU);
a system memory, accessible to the CPU, including processor-executable instructions that, when executed by the CPU, cause the system to perform edge server management operations, comprising:
creating a host folder;
associating the host folder with an element manager;
adding one or more edge servers to the host folder; and
managing the one or more edge servers with an edge server management system running in the element manager instance.

12. The information handling system of claim 11, wherein creating the host folder comprises creating the host folder from a server manager running in a virtualization platform user interface (UI).

13. The information handling system of claim 11, wherein creating the host folder comprises creating the host folder from an element manager user interface (UI).

14. The information handling system of claim 11, wherein the adding of the edge server to a host folder comprises adding the edge server via the element manager user interface (UI).

15. The information handling system of claim 14, wherein the element manager UI comprises a plugin UI for the server manager running on virtualization platform.

16. The information handling system of claim 11, wherein managing the one or more edge servers includes performing health monitoring of the one or more edge servers.

17. The information handling system of claim 16, wherein performing the health monitoring includes deploying an edge server agent to:
receive change events published by the edge server; and
redirect the change events to an element manager system.

18. The information handling system of claim 17, wherein deploying the edge server agent comprises deploying the edge server agent to receive change events published by a baseboard management controller of the edge server.

19. The information handling system of claim 11, wherein managing the one or more edge servers with the element manager includes performing life cycle management of the one or more edge servers and wherein the performing of life cycle management includes:
monitoring version information for the one or more edge servers to report information including:
which edge servers are upgrade eligible; and
which versions can be applied to upgrade eligible servers.

20. The information handling system of claim 19, wherein performing life cycle management of the one or more edge servers includes providing a user with version upgrading options including:
direct upgrading wherein version upgrading commences when an upgrading bundle transfer completes; and
scheduled upgrading wherein version upgrading commences during a future maintenance window.
